(19) United States
(12) Patent Application Publication
(10) Pub. No.: US 2026/0276796 A1
(43) Pub. Date: Sep. 17, 2026

(54) SLAM APPARATUS, SLAM ATTACK COUNTERMEASURE METHOD, AND COMPUTER READABLE MEDIUM

(71) Applicant: Mitsubishi Electric Corporation, Tokyo (JP)

(72) Inventor: Masashi FUKUNAGA, Tokyo (JP)

(73) Assignee: Mitsubishi Electric Corporation, Tokyo (JP)

(21) Appl. No.: 19/683,068

(22) Filed: May 20, 2026

Related U.S. Application Data
(63) Continuation of application No. PCT/JP2024/000012, filed on Jan. 4, 2024.

(51) Int. Cl. G01S 7/495; G01S 17/87; G01S 17/89; G05D 1/246

(52) U.S. Cl. CPC G01S 7/495; G01S 17/87; G01S 17/89; G05D 1/246

(57) ABSTRACT

A LiDAR SLAM unit (111) executes SLAM using measurement data obtained from a lidar sensor installed in a mobile object and generates a lidar SLAM map. A camera SLAM unit (112) executes SLAM using measurement data obtained from a distance image camera installed in the mobile object and generates a camera SLAM map. An attack determination unit (122) determines whether or not the lidar sensor has been attacked based on a difference between the lidar SLAM map and the camera SLAM map.

### CROSS REFERENCE TO RELATED APPLICATIONS

This application is a Continuation of PCT International Application No. PCT/JP2024/000012 filed on Jan. 4, 2024, all of which is hereby expressly incorporated by reference into the present application.

### TECHNICAL FIELD

The present disclosure relates to a countermeasure against an attack on SLAM (SLAM).

### BACKGROUND ART

An automated driving system uses a plurality of sensors to implement safe driving control of a mobile object. While covering each other's strengths and weaknesses, the plurality of sensors measure surrounding situations of the mobile object.

The use of the plurality of sensors in this manner is referred to as sensor fusion.

There is SLAM as a technology that uses sensor data in the automated driving system.

SLAM is a technology that simultaneously performs estimation of a self-location of the mobile object and generation of an environmental map. By using SLAM, it is possible to implement safe driving even in places where the mobile object has been for the first time.

SLAM is an abbreviation for Simultaneous Localization and Mapping.

There is a problem that attacks are carried out on the automated driving system via the sensors under certain circumstances.

Attacks are carried out on SLAM which is an application used in the automated driving system, for example. As a result of a SLAM attack, a victim (mobile object) may miscalculate positioning and then accelerate or decelerate abruptly.

Patent Literature 1 discloses a technology for solving the above problem.

Specifically, Patent Literature 1 discloses a SLAM interpolation technology that uses measurement data of LiDAR (lidar) and measurement data of a camera. This technology is for taking a countermeasure within an application against an attack that performs synchronous spoofing on LiDAR and affects SLAM using the spoofed data.

LiDAR is an abbreviation for Light Detection And Ranging.

### CITATION LIST

### Patent Literature

Patent Literature 1: WO 2023-139793 A1

### SUMMARY OF INVENTION

### Technical Problem

The present disclosure aims to enable determination of the presence or absence of an attack on a lidar sensor used for SLAM.

### Solution to Problem

A SLAM apparatus according to the present disclosure includes:
a lidar SLAM unit to execute SLAM using measurement data obtained from a lidar sensor installed in a mobile object and to generate a lidar SLAM map;
a camera SLAM unit to execute SLAM using measurement data obtained from a distance image camera installed in the mobile object and to generate a camera SLAM map; and
an attack determination unit to determine whether or not the lidar sensor has been attacked based on a difference between the lidar SLAM map and the camera SLAM map.

### Advantageous Effects of Invention

According to the present disclosure, it is possible to determine the presence or absence of an attack on a lidar sensor used for SLAM.

### BRIEF DESCRIPTION OF DRAWINGS

FIG. 1 is a configuration diagram of a SLAM apparatus 100 in Embodiment 1.

FIG. 2 is a diagram of a configuration of a mobile object 200 in Embodiment 1.

FIG. 3 is a diagram of a functional configuration of the SLAM apparatus 100 in Embodiment 1.

FIG. 4 is a flowchart of a SLAM attack countermeasure method in Embodiment 1.

FIG. 5 is a diagram illustrating an example of a processing flow of the SLAM attack countermeasure method in Embodiment 1.

FIG. 6 is a diagram of a hardware configuration of the SLAM apparatus 100 in Embodiment 1.

### DESCRIPTION OF EMBODIMENTS

In the Embodiments and drawings, the same elements or corresponding elements are denoted by the same reference sign. Description of an element denoted by the same reference sign as that of an element that has been described will be suitably omitted or simplified. Arrows in diagrams mainly indicate flows of data or flows of processing.

### Embodiment 1

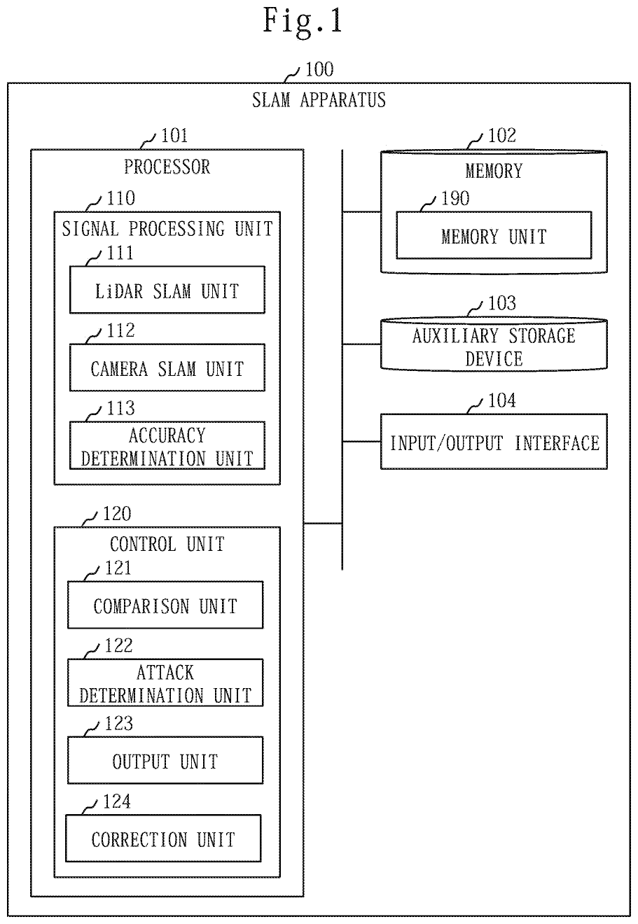

A SLAM attack countermeasure will be described based on FIGS. 1 to 6.

### Description of Configuration

A configuration of a SLAM apparatus 100 will be described based on FIG. 1.

The SLAM apparatus 100 is a computer that includes pieces of hardware such as a processor 101, a memory 102, an auxiliary storage device 103, and an input/output interface 104. These pieces of hardware are connected with one another through signal lines.

The processor 101 is an IC that performs arithmetic processing and controls other pieces of hardware. The processor 101 is a CPU.

IC is abbreviation for Integrated Circuit.

CPU is abbreviation for Central Processing Unit.

The memory 102 is a volatile or non-volatile storage device. The memory 102 is also referred to as a main storage device or a main memory. The memory 102 is, for example, an RAM. Data stored in the memory 102 is saved in the auxiliary storage device 103 as necessary.

RAM is an abbreviation for Random Access Memory.

The auxiliary storage device 103 is a non-volatile storage device. The auxiliary storage device 103 is, for example, an ROM, an HDD, a flash memory, or a combination of these. Data stored in the auxiliary storage device 103 is loaded into the memory 102 as necessary.

ROM is abbreviation for Read Only Memory.

HDD is abbreviation for Hard Disk Drive.

The input/output interface 104 is a port to which input devices and output devices are connected. The input/output interface 104 connects to, for example, a sensor group 210 and a control apparatus 220 to be described below.

USB is an abbreviation for Universal Serial Bus.

The SLAM apparatus 100 includes elements such as a signal processing unit 110 and a control unit 120. These elements are implemented by software.

The auxiliary storage device 103 stores a SLAM attack countermeasure program for causing a computer to function as the signal processing unit 110 and the control unit 120. The SLAM attack countermeasure program is loaded into the memory 102 and executed by the processor 101.

The auxiliary storage device 103 also stores an OS. At least a part of the OS is loaded into the memory 102 and executed by the processor 101.

While executing the OS, the processor 101 also executes the SLAM attack countermeasure program.

OS is an abbreviation for Operating System.

Input/output data of the SLAM attack countermeasure program is stored in a storage unit 190.

The memory 102 functions as the storage unit 190. However, storage devices such as the auxiliary storage device 103, a register in the processor 101, and a cache memory in the processor 101 may also function as the storage unit 190 instead of the memory 102 or together with the memory 102.

The SLAM attack countermeasure program can be recorded (stored) on a non-volatile storage medium such as an optical disc or a flash memory in a computer readable format.

The SLAM apparatus 100 is installed in a mobile object 200 that moves automatically using SLAM.

Examples of the mobile object 200 are an autonomous vehicle, an autonomous mobile robot, and a drone.

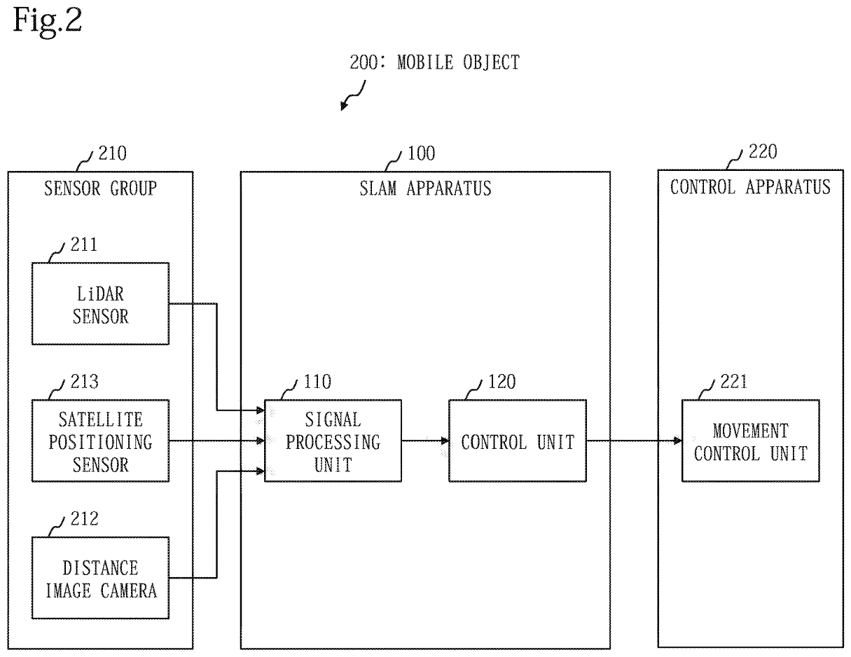

A configuration of the mobile object 200 will be described based on FIG. 2.

The mobile object 200 is installed with the SLAM apparatus 100, the sensor group 210, and the control apparatus 220.

The sensor group 210 is a plurality of types of sensors.

The sensor group 210 includes a LiDAR sensor 211, a distance image camera 212, and a satellite positioning sensor 213.

The distance image camera 212 is a camera that measures a distance to a target object based on a round-trip flight time (ToF: Time of Flight) of light such as infrared or visible light. The distance image camera 212 can output image data that includes distance data. In other words, the distance image camera 212 can perform odometry without requiring special point cloud processing. On the other hand, additional information such as an amount of movement is necessary to measure the distance using a regular camera. The distance image camera 212 is also referred to as a distance image sensor.

The satellite positioning sensor 213 is a sensor that performs positioning using a satellite positioning system. An example of the satellite positioning system is a Global Positioning System (GPS).

In addition to the LiDAR sensor 211, the distance image camera 212, and the satellite positioning sensor 213, the sensor group 210 may also include a radar and a sonar.

The control apparatus 220 is a computer that includes an element called a movement control unit 221.

The movement control unit 221 performs control (movement control) such as movement, suspension, and direction changing of the mobile object 200. Specifically, the movement control unit 221 controls a power device and a steering device of the mobile object 200. An example of the power device is a wheel and a motor. Illustrations of the power device and the steering device are omitted.

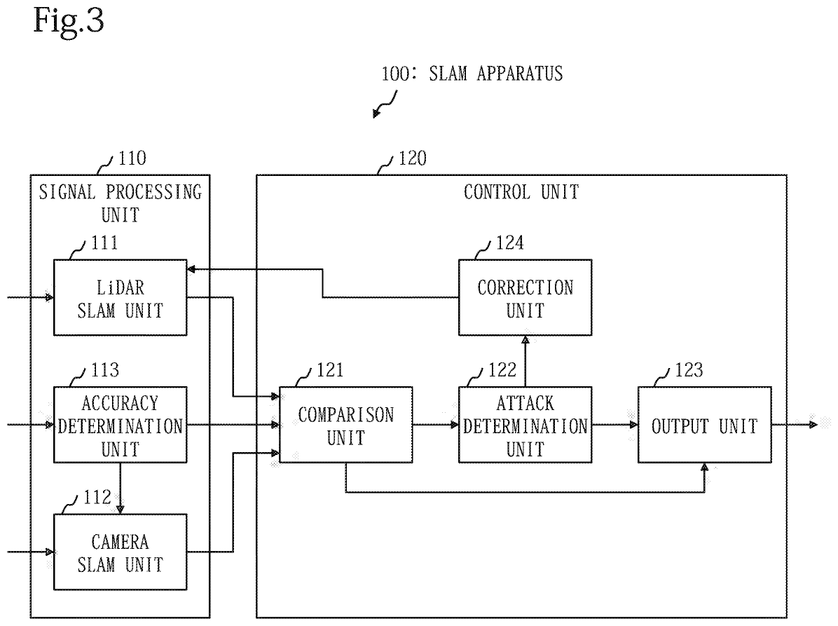

FIG. 3 illustrates a functional configuration of the SLAM apparatus 100.

The signal processing unit 110 includes elements such as a LiDAR SLAM unit 111, a camera SLAM unit 112, and an accuracy determination unit 113.

The control unit 120 includes elements such as a comparison unit 121, an attack determination unit 122, an output unit 123, and a correction unit 124.

### Description of Operation

A procedure for operation of the SLAM apparatus 100 is equivalent to a SLAM attack countermeasure method. The procedure for the operation of the SLAM apparatus 100 is also equivalent to a procedure for processing by the SLAM attack countermeasure program.

The SLAM attack countermeasure method will be described below.

The LiDAR sensor 211 performs LiDAR measurements on surroundings of the mobile object 200 and outputs measurement data. The outputted measurement data is inputted into the LiDAR SLAM unit 111.

The distance image camera 212 performs ToF measurements on the surroundings of the mobile object 200 and outputs measurement data. The outputted measurement data is inputted into the camera SLAM unit 112.

A measurement time interval of the distance image camera 212 is shorter than a measurement time interval of the LiDAR sensor 211. The distance image camera 212 obtains two or more pieces of measurement data for each piece of measurement data obtained by the LiDAR sensor 211.

The satellite positioning sensor 213 performs satellite positioning and outputs satellite positioning data. The outputted satellite positioning data is inputted into the accuracy determination unit 113.

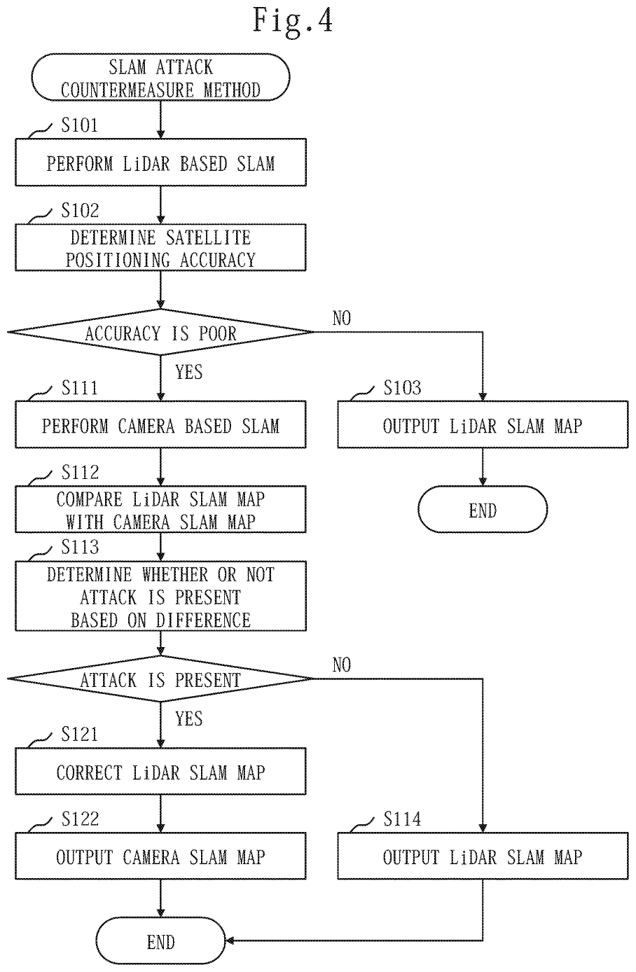

A procedure for the SLAM attack countermeasure method will be described based on FIG. 4.

The procedure for the SLAM attack countermeasure method is executed repeatedly.

In step S101, the LiDAR SLAM unit 111 executes SLAM using the measurement data obtained from the LiDAR sensor 211.

In SLAM, point cloud processing and odometry are executed using the measurement data.

The point cloud processing is processing that generates a point cloud that represents a plurality of measured points (measurement points).

Odometry is a technique used to derive a trajectory of a location. Known techniques can be used for odometry.

By executing SLAM, a location of the mobile object 200 is estimated and a map of the surroundings of the mobile object 200 is generated.

SLAM performed using the measurement data of the LiDAR sensor 211 is referred to as LiDAR based SLAM.

The map generated by LiDAR based SLAM is referred to as a LiDAR SLAM map or a LiDAR based SLAM map.

The location estimated by LiDAR based SLAM is referred to as a LiDAR SLAM location or a LiDAR based SLAM location.

The LiDAR SLAM unit 111 outputs LiDAR SLAM data.

The LiDAR SLAM data indicates the LiDAR SLAM location and the LiDAR SLAM map.

The outputted LiDAR SLAM data is inputted into the comparison unit 121.

In step S102, the accuracy determination unit 113 determines whether or not positioning accuracy of the satellite positioning sensor 213 is poor based on the satellite positioning data obtained from the satellite positioning sensor 213.

The accuracy determination unit 113 determines whether or not the positioning accuracy of the satellite positioning sensor 213 is poor in the following manner, for example.

The satellite positioning data includes information indicating the number of satellites tracked. The number of satellites tracked is the number of positioning satellites being tracked. The positioning satellite being tracked is a positioning satellite which is a source of a positioning signal received by the satellite positioning sensor 213. When the mobile object 200 enters a tunnel, the satellite positioning sensor 213 is unable to track positioning satellites, for example. When the number of satellites tracked is low, the positioning accuracy of the satellite positioning sensor 213 decreases because the positioning accuracy of the satellite positioning sensor 213 cannot be maintained. Otherwise, a location of the satellite positioning sensor 213 cannot be specified.

The accuracy determination unit 113 determines whether or not the positioning accuracy of the satellite positioning sensor 213 is poor based on the number of satellites tracked indicated in the satellite positioning data.

When the number of satellites tracked is low (when the number of satellites tracked is less than a threshold value), the accuracy determination unit 113 determines that the positioning accuracy of the satellite positioning sensor 213 is poor.

Then, the accuracy determination unit 113 outputs a determination result. The outputted determination result is inputted into the camera SLAM unit 112 and the comparison unit 121.

When it is determined that the positioning accuracy of the satellite positioning sensor 213 is not poor, the process proceeds to step S103.

In this case, the LiDAR SLAM unit 111 may execute SLAM using a satellite positioning result and regenerate LiDAR SLAM data. As a result, accuracy of self-location estimation is improved.

The satellite positioning result indicates a location estimated by the satellite positioning of the satellite positioning sensor 213, and is included in the satellite positioning data.

The regenerated LiDAR SLAM data is inputted into the comparison unit 121.

In step S103, the comparison unit 121 receives the LiDAR SLAM data and the determination result that the accuracy of the satellite positioning sensor 213 is not poor, and outputs the LiDAR SLAM data. The outputted LiDAR SLAM data is inputted into the output unit 123.

The output unit 123 receives the LiDAR SLAM data and outputs the LiDAR SLAM map. The outputted LiDAR SLAM map is inputted into the movement control unit 221.

The movement control unit 221 receives the LiDAR SLAM map and performs the movement control on the mobile object 200 using the LiDAR SLAM map.

After step S103, one procedure of the SLAM attack countermeasure method ends.

In step S102, when it is determined that the positioning accuracy of the satellite positioning sensor 213 is poor, the process proceeds to step S111.

In step S111, the camera SLAM unit 112 receives the determination result that the positioning accuracy of the satellite positioning sensor 213 is poor and controls the distance image camera 212 to operate the distance image camera 212.

Next, the camera SLAM unit 112 executes SLAM using the measurement data obtained from the distance image camera 212.

SLAM performed using the measurement data from the distance image camera 212 is referred to as camera based SLAM. Since the distance image camera 212 can measure both an image and a distance, the distance image camera 212 can implement odometry without requiring special point cloud processing.

The map generated by camera based SLAM is referred to as a camera SLAM map or a camera based SLAM map.

The location estimated by camera based SLAM is referred to as a camera SLAM location or a camera based SLAM location.

The camera SLAM unit 112 outputs camera SLAM data.

The camera SLAM data indicates the camera SLAM location and the camera SLAM map.

The outputted camera SLAM data is inputted into the comparison unit 121.

The camera SLAM unit 112 obtains two or more pieces of measurement data of the distance image camera 212 and outputs the camera SLAM data for each measurement data of the distance image camera 212.

Then, the camera SLAM unit 112 controls the distance image camera 212 to suspend the distance image camera 212.

In step S112, the comparison unit 121 receives the LiDAR SLAM data, the camera SLAM data, and the determination result that the positioning accuracy of the satellite positioning sensor 213 is poor.

Next, the comparison unit 121 compares the LiDAR SLAM map with the camera SLAM map and calculates a difference between the LiDAR SLAM map and the camera SLAM map.

The comparison unit 121 overlays the camera SLAM map onto the LiDAR SLAM map and calculates a difference between a point cloud in the camera SLAM map and a point cloud in the LiDAR SLAM map, for example. The calculated difference is the difference between the LiDAR SLAM map and the camera SLAM map.

The comparison unit 121 compares the LiDAR SLAM map with the camera SLAM map for each piece of inputted camera SLAM data and calculates the difference.

In other words, the comparison unit 121 compares one LiDAR SLAM map with each of two or more camera SLAM maps and calculates two or more differences corresponding to the two or more camera SLAM maps.

The comparison unit 121 may further compare the LiDAR SLAM location with the camera SLAM location and calculate a difference between (trajectories of) the LiDAR SLAM location and the camera SLAM location.

Then, the comparison unit 121 outputs the LiDAR SLAM data, the camera SLAM data, and difference data.

The difference data indicates the calculated difference.

The outputted data is inputted into the attack determination unit 122.

In step S113, the attack determination unit 122 receives the LiDAR SLAM data, the camera SLAM data, and the difference data.

Next, the attack determination unit 122 determines whether or not the LiDAR sensor 211 has been attacked based on the difference between the LiDAR SLAM map and the camera SLAM map.

The attack determination unit 122 calculates a statistical value of the two or more differences corresponding to the two or more camera SLAM maps, for example. Then, the attack determination unit 122 uses the calculated statistical value to determine whether or not the LiDAR sensor 211 has been attacked.

An example of the statistical value is a standard error. When the standard error deviates from a predetermined range, the attack determination unit 122 determines that the LiDAR sensor 211 has been attacked. When a standard error σ is less than or equal to −2.3, or equal to or greater than 2.3σ, the attack determination unit 122 determines that the LiDAR sensor 211 has been attacked. The predetermined range is appropriately set according to the performance of the LiDAR sensor 211 and the distance image camera 212, or the type of the mobile object 200.

The attack determination unit 122 may determine whether or not the LiDAR sensor 211 has been attacked, based on the difference between the LiDAR SLAM map and the camera SLAM map and the difference between the LiDAR SLAM location and the camera SLAM location.

When the LiDAR sensor 211 has been attacked, it is considered that there is an anomaly in the LiDAR SLAM map.

When it is determined that the LiDAR sensor 211 has been attacked, the attack determination unit 122 outputs the camera SLAM data. The outputted camera SLAM data is inputted into the output unit 123.

In this case, the attack determination unit 122 also outputs the LiDAR SLAM data. The outputted LiDAR SLAM data is inputted into the correction unit 124.

When it is determined that the LiDAR sensor 211 has not been attacked, the attack determination unit 122 outputs the LiDAR SLAM data. The outputted LiDAR SLAM data is inputted into the output unit 123.

When it is determined that the LiDAR sensor 211 has not been attacked, the process proceeds to step S114.

In step S114, the output unit 123 receives the LiDAR SLAM data and outputs the LiDAR SLAM map.

The outputted LiDAR SLAM map is inputted into the movement control unit 221.

The movement control unit 221 receives the LiDAR SLAM map and performs the movement control on the mobile object 200 using the LiDAR SLAM map.

After step S114, one procedure of the SLAM attack countermeasure method ends.

When it is determined in step S113 that the LiDAR sensor 211 has been attacked, the process proceeds to step S121.

In step S121, the correction unit 124 receives the LiDAR SLAM data and corrects the LiDAR SLAM map.

Specifically, the correction unit 124 deletes a point cloud of outliers from the LiDAR SLAM map. The outliers are values that deviate from the standard error.

The corrected LiDAR SLAM map is considered to be a map created by LiDAR based SLAM, and is used for trajectory planning, determining surrounding situations, and the like.

The correction unit 124 outputs the corrected LiDAR SLAM map.

The outputted LiDAR SLAM map is inputted into the LiDAR SLAM unit 111 and is used for the next LiDAR based SLAM, for example.

In step S122, the output unit 123 receives the camera SLAM data and outputs the camera SLAM map.

The outputted camera SLAM map is inputted into the movement control unit 221.

The movement control unit 221 receives the camera SLAM map and performs the movement control on the mobile object 200 using the camera SLAM map.

After step S122, one procedure of the SLAM attack countermeasure method ends.

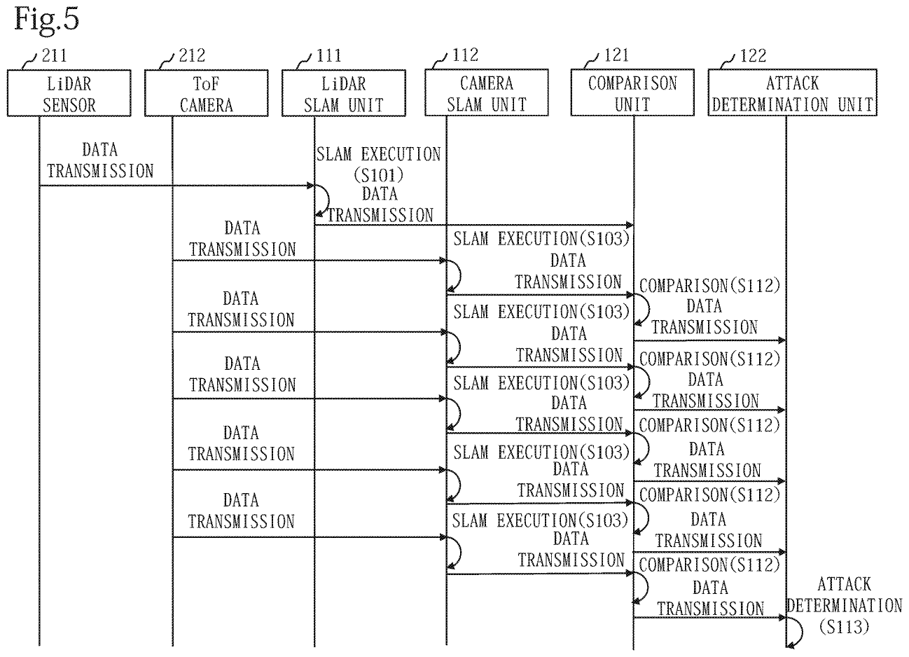

An example of a processing flow of the SLAM attack countermeasure method will be described based on FIG. 5.

In this example, it is assumed that the positioning accuracy of the satellite positioning sensor 213 is poor.

The LiDAR sensor 211 transmits the measurement data, and the LiDAR SLAM unit 111 executes LiDAR based SLAM to transmit the LiDAR SLAM map to the comparison unit 121 (step S101).

Through LiDAR based SLAM, the LiDAR sensor 211 generates the LiDAR SLAM map every 1 Hz and performs self-location estimation every 10 Hz, for example. Although it also depends on laser output, the LiDAR sensor 211 has a wide measurement range (about 100 meters). Therefore, a wide-area LiDAR SLAM map is generated. It is possible to minimize a deviation in self-location and secure time for feature extraction for map generation, by performing high-speed estimation of a self-location and low-speed generation of a map separately.

The distance image camera 212 transmits the measurement data, and the camera SLAM unit 112 executes camera based SLAM to transmit the camera SLAM map to the comparison unit 121 (step S103).

Through camera based SLAM, the camera SLAM unit 112 generates the camera SLAM map every 5 Hz and performs self-location estimation every 50 Hz, for example. The distance image camera 212 has a narrow measurement range (about a few meters). Therefore, a narrow-area camera SLAM map is generated.

Generally, a frame rate (measurement time interval) of a distance image sensor is higher than that of a LiDAR sensor. Therefore, a camera SLAM map can be generated with higher accuracy.

It is assumed that a frame rate of the distance image camera 212 is one fifth of a frame rate of the LiDAR sensor 211.

The comparison unit 121 performs comparison using five camera SLAM maps for a single LiDAR SLAM map, and transmits the difference data to the attack determination unit 122 (step S112).

It is possible to modify the number of maps used for the comparison by modifying each frame rate.

The attack determination unit 122 determines whether or not the LiDAR sensor 211 has been attacked based on the difference data (step S113).

### Effects of Embodiment 1

Embodiment 1 enables the prevention of an interference attack on a sensor and an attack intended to deceive sensor fusion.

In Embodiment 1, when the positioning accuracy of the satellite positioning sensor 213 is low, the distance image camera 212 operates. As a result, it is possible to reduce operation of an unnecessary function under normal states.

Although the measurement data of the distance image camera 212 can only be used in a narrow range, its measuring accuracy is excellent.

When the positioning accuracy of the satellite positioning sensor 213 is low, the mobile object 200 is often in a narrow place such as the inside of a three-dimensional structure building or the inside of a tunnel. A condition that the mobile object 200 is in the narrow place is optimal as a condition to use the distance image camera 212. Therefore, even when the LiDAR sensor 211 is under attack, the mobile object 200 can perform safe movement using the camera SLAM map.

### Supplement to Embodiment 1

The SLAM apparatus 100 performs estimation of self-location and generation of a surrounding environmental map to safely move the mobile object 200.

In movement during normal times (during not under attack), the SLAM apparatus 100 performs the estimation of self-location using the LiDAR sensor 211 and the satellite positioning sensor 213.

When the positioning accuracy of the satellite positioning sensor 213 deteriorates for a reason such as an inability to capture satellites inside a tunnel, the distance image camera 212 is used.

The signal processing unit 110 executes SLAM using the measurement data of the LiDAR sensor 211 and the measurement data of the distance image camera 212.

At normal times, the signal processing unit 110 obtains the measurement data (signals) only from the LiDAR sensor 211 and executes LiDAR based SLAM that uses the measurement data of the LiDAR sensor 211.

When the measurement data is transmitted from the distance image camera 212, the signal processing unit 110 performs SLAM using each of the measurement data of the LiDAR sensor 211 and the measurement data of the distance image camera 212, and performs data processing (signal processing) for comparison.

The procedure for the SLAM attack countermeasure method is equivalent to a sensor fusion SLAM algorithm that uses the distance image camera 212 and the LiDAR sensor 211.

When the positioning accuracy of GPS is poor, the signal processing unit 110 executes a countermeasure using the distance image camera 212.

When the positioning accuracy of GPS is poor, the control unit 120 performs correction according to comparison of a wide-area map created by LiDAR based SLAM with a narrow-area map created by camera based SLAM.

When the positioning accuracy of GPS is poor, the SLAM apparatus 100 considers the priority of the distance image camera 212 is high and performs sensor fusion signal processing. Since no new processing needs to be added for the distance image camera 212, it is easy to meet a time requirement at implementation.

The SLAM apparatus 100 uses the distance image camera 212. The distance image camera 212 performs measurement through a pattern irradiation method whose frame rate is 10 times that of the LiDAR sensor 211.

The control unit 120 performs comparison using five camera based SLAM maps for one LiDAR based SLAM map and performs attack detection through statistical processing.

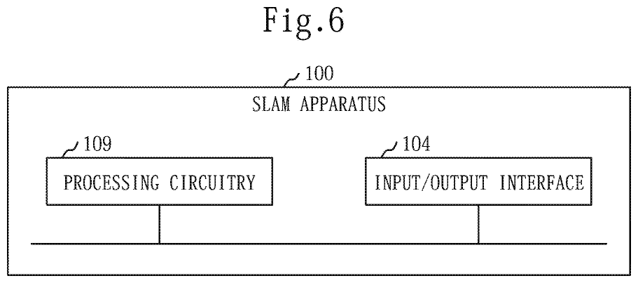

A hardware configuration of the SLAM apparatus 100 will be described based on FIG. 6.

The SLAM apparatus 100 includes processing circuitry 109.

The processing circuitry 109 is a piece of hardware that implements the signal processing unit 110 and the control unit 120.

The processing circuitry 109 may be dedicated hardware or may be the processor 101 that executes programs stored in the memory 102.

When the processing circuitry 109 is the dedicated hardware, the processing circuitry 109 is, for example, a single circuit, a compound circuit, a programmed processor, a parallel programmed processor, an ASIC, an FPGA, or a combination of these.

ASIC is an abbreviation for Application Specific Integrated Circuit.

FPGA is an abbreviation for Field Programmable Gate Array.

The SLAM apparatus 100 may include a plurality of pieces of processing circuitry as an alternative to the processing circuitry 109.

In the processing circuitry 109, some functions may be implemented by the dedicated hardware, while the remaining functions may be implemented by software or firmware.

In such a manner, a function of the SLAM apparatus 100 can be implemented by hardware, software, firmware, or a combination of these.

Embodiment 1 is an example of a preferable embodiment and is not intended to limit the technical scope of the present disclosure. Embodiment 1 may be implemented partially or may be implemented in combination with another embodiment. The procedures described using the flowcharts or the like may be suitably modified.

“Unit” of each element of the SLAM apparatus 100 may be read and interpreted as “process”, “step”, “circuit” or “circuitry”.

### REFERENCE SIGNS LIST

100: SLAM apparatus; 101: processor; 102: memory; 103: auxiliary storage device; 104: input/output interface; 109: processing circuitry; 110: signal processing unit; 111: LiDAR SLAM unit; 112: camera SLAM unit; 113: accuracy determination unit; 120: control unit; 121: comparison unit; 122: attack determination unit; 123: output unit; 124: correction unit; 190: storage unit; 200: mobile object; 210: sensor group; 211: LiDAR sensor; 212: distance image camera; 213: satellite positioning sensor; 220: control apparatus; 221: movement control unit.

1. A SLAM apparatus comprising:
processing circuitry:
to execute SLAM using measurement data obtained from a lidar sensor installed in a mobile object and to generate a lidar SLAM map;
to execute SLAM using measurement data obtained from a distance image camera installed in the mobile object and to generate a camera SLAM map; and
to determine whether or not the lidar sensor has been attacked based on a difference between the lidar SLAM map and the camera SLAM map.

2. The SLAM apparatus according to claim 1, wherein
the processing circuitry determines positioning accuracy of a satellite positioning sensor based on satellite positioning data obtained from the satellite positioning sensor installed in the mobile object,
the processing circuitry, when it is determined that the positioning accuracy of the satellite positioning sensor is poor, generates the camera SLAM map, and
the processing circuitry, when it is determined that the positioning accuracy of the satellite positioning sensor is poor, determines whether or not the lidar sensor has been attacked.

3. The SLAM apparatus according to claim 2, wherein
the processing circuitry, when it is determined that the positioning accuracy of the satellite positioning sensor is poor, obtains the measurement data of the distance image camera by operating the distance image camera.

4. The SLAM apparatus according to claim 2, wherein
the mobile object comprises a control apparatus to control movement of the mobile object using a SLAM map generated by SLAM, and
the processing circuitry, when it is determined that the lidar sensor has been attacked, outputs the camera SLAM map to the control apparatus, and when it is determined that the lidar sensor has not been attacked, outputs the lidar SLAM map to the control apparatus.

5. The SLAM apparatus according to claim 4, wherein
the processing circuitry, when it is not determined that the positioning accuracy of the satellite positioning sensor is poor, outputs the lidar SLAM map to the control apparatus.

6. The SLAM apparatus according to claim 1, wherein
the processing circuitry comperes the lidar SLAM map with the camera SLAM map and calculates the difference between the lidar SLAM map and the camera SLAM map.

7. The SLAM apparatus according to claim 6, wherein
a measurement time interval of the distance image camera is shorter than a measurement time interval of the lidar sensor, and two or more pieces of measurement data of the distance image camera are obtained for one piece of measurement data of the lidar sensor,
the processing circuitry generates one lidar SLAM map using the one piece of measurement data of the lidar sensor,
the processing circuitry generates two or more camera SLAM maps using the two or more pieces of measurement data of the distance image camera,
the processing circuitry compares the one lidar SLAM map with each of the two or more camera SLAM maps and calculates two or more differences corresponding to the two or more camera SLAM maps, and
the processing circuitry calculates a statistical value of the two or more differences and determines whether or not the lidar sensor has been attacked using the calculated statistical value.

8. The SLAM apparatus according to claim 1, wherein
the processing circuitry, when it is determined that the lidar sensor has been attacked, corrects the lidar SLAM map.

9. A SLAM attack countermeasure method comprising:
executing SLAM using measurement data obtained from a lidar sensor installed in a mobile object and generating a lidar SLAM map;
executing SLAM using measurement data obtained from a distance image camera installed in the mobile object and generating a camera SLAM map; and
determining whether or not the lidar sensor has been attacked based on a difference between the lidar SLAM map and the camera SLAM map.

10. A non-transitory commuter readable medium storing a SLAM attack countermeasure program for causing a computer to execute:
a lidar SLAM process to execute SLAM using measurement data obtained from a lidar sensor installed in a mobile object and to generate a lidar SLAM map;
a camera SLAM process to execute SLAM using measurement data obtained from a distance image camera installed in the mobile object and to generate a camera SLAM map; and
an attack determination process to determine whether or not the lidar sensor has been attacked based on a difference between the lidar SLAM map and the camera SLAM map.
